(19) United States
(12) Patent Application Publication
(10) Pub. No.: US 2006/0254010 A1
(43) Pub. Date: Nov. 16, 2006

(54) Interproximal tool

(76) Inventor: Eugene Wagner, Pacific Palisades, CA (US)

Correspondence Address: ROBERT S. SALZMAN;P.O. BOX 314, MILLINGTON, NJ, 07946, US

(21) Appl. No.: 11/127,835

(22) Filed: May 13, 2005

(51) Int. Cl. A61C 15/00; A46B 9/04

(52) U.S. Cl. 15/167.1; 15/206; 132/329

(57) ABSTRACT

A series of tools for interproximal cleaning of teeth that can be part of a kit of tools, each having a single handheld base, or they can be part of a kit of separate handheld tools. Each tool has a curved, or arcuate probe disposed at the distal end of the handheld tool. Brush elements or hardened rubber or plastic beads are respectively disposed along the curved surface of the probes.

### FIELD OF THE INVENTION

This invention pertains to health hygiene, and more particularly to improved interproximal tools that provide greater efficacy in approaching dental surfaces about the oral cavity. The tools can be presented individually, or as a kit of stylized probes that fit a single handle.

### BACKGROUND OF THE INVENTION

It is well known in the art of interproximal cleaning of the teeth, to provide brushes at the distal end of oral tools. These brushes are sometimes angled at ninety degrees to the distal end of the handheld probe, and sometimes they are angled at one hundred and thirty five degrees. The brushes are sometimes straight, and sometimes they are tapered towards a proximal point. A typical type of interproximal brush of which is spoken of here, can be viewed in the United States patents to Simms, U.S. Pat. Nos. 5,309,596 and 5,377,377.

The problem with the above types of interproximal tools are their inability to reach certain areas of the mouth. The inner cavities and spaces of the jaw present daunting and inaccessible challenges to ordinary interproximal brush elements that are described above.

In addition to the problem of inaccessibility, is the problem of the inability of these soft bristle brushes to remove hardened plaque that clings to the recessed enamel surfaces.

The present invention seeks to solve the problem of cleaning inaccessible gum and tooth surfaces, by providing a series of tools, or a tool kit. Each handheld tool comprises a cleaning probe disposed at an approximate zero angle of attack from the distal handle end of the tool. Each probe is rigid, and has brushes or hard plastic spaced-apart beads, (EVA) rubber filaments, or semi-abrasive sleeves of hardened foam. The brushes or beads are disposed upon an arcuate or curved, elongated surface of the probe. The curved, rigid probe projects from the distal end of the handheld tool.

The rigid nature of the probe is contraindicated from the teachings of similar interproximal probes. Most interproximal probes are flexible. The present invention has discovered that by making the elongated wire of the probe substantially inflexible, one is able to provide a robust cleaning of interproximal areas, with greater access and efficacy.

The arcuate nature of the elongated probe provides greater accessibility to curving tooth surfaces, and inner reaches of the jaw cavity.

The hardened rubber or plastic beads disposed along the curved length of the probe, also provide a more efficacious surface-to-surface cleaning of hardened plaque surfaces of the teeth. Spaced-apart hardened filaments can also be used.

### SUMMARY OF THE INVENTION

In accordance with the present invention, a series of interproximal tools for cleaning hard to reach surfaces of the oral cavity, are described. The handheld tools each have a cleaning attachment probe disposed at approximate zero angle of attack from the distal handle end of the probe, as illustrated hereinafter, in the figures and detailed description. Each of the probe wires are rigid and essentially non-flexible. Each wire comprises a tooth cleaning means comprising brushes, filaments, or hard plastic or (EVA) rubber beads. The brushes, filaments, or beads are spaced-apart along the arcuate or curved, elongated probe surface. The arcuate nature of the elongated probe provides greater accessibility to curving tooth surfaces, and inner reaches of the jaw cavity. The hardened rubber or plastic beads disposed along the curved length of the probe, provide a more robust surface-to-surface cleaning of hardened plaque surfaces of the teeth. The rigid nature of the probe wire, allows the user to more forcefully, and efficaciously interpose the wire between and around the teeth. The curvature, rigidity, and hardened surfaces of the probe combine to provide a superior interproximal tool for cleaning teeth.

It is also contemplated by this invention to provide a single handle, with various probe attachments, so that a versatile tool kit can be achieved.

It is an object of this invention to provide a tool kit of versatile curved probes for cleaning teeth.

It is another object of the invention to provide improved interproximal cleaning tools for teeth.

### BRIEF DESCRIPTION OF THE DRAWINGS

A complete understanding of the present invention may be obtained by reference to the accompanying drawings, when considered in conjunction with the subsequent detailed description, in which:

FIG. 1 illustrates a handheld, interproximal, tooth-cleaning tool having a curved brush probe projecting from its distal end;

FIG. 2 depicts a second embodiment of the tool of FIG. 1, wherein the probe comprises a series or spaced-apart beads disposed along the arcuate length of the probe;

FIG. 3 shows a third embodiment of the tool of FIG. 1, wherein the probe comprises a tapered brush disposed at the end of the curbed probe;

FIG. 4 illustrates a fourth embodiment of the tool shown in FIG. 1, wherein a brush is disposed along a mid-portion of the curved surface of the probe; and

FIG. 5 depicts a fifth embodiment of the tool shown in FIG. 1, wherein a semi-rigid, semi-abrasive foam is disposed about the distal end of the curved surface of the rigid probe of this invention.

### DESCRIPTION OF THE PREFERRED EMBODIMENT

Generally speaking, a series of tools for interproximal cleaning of teeth are shown. The tools can be part of a kit of tools, each having a single handheld base, or they can be part of a kit of separate handheld tools. Each tool has a curved, or arcuate, rigid probe wire disposed at the distal end of the handheld tool. Cleaning elements, such as brushes, filaments, or hardened rubber or plastic beads are respectively disposed along the curved surface of each probe. The filaments may be soft, flexible, and brush-like.

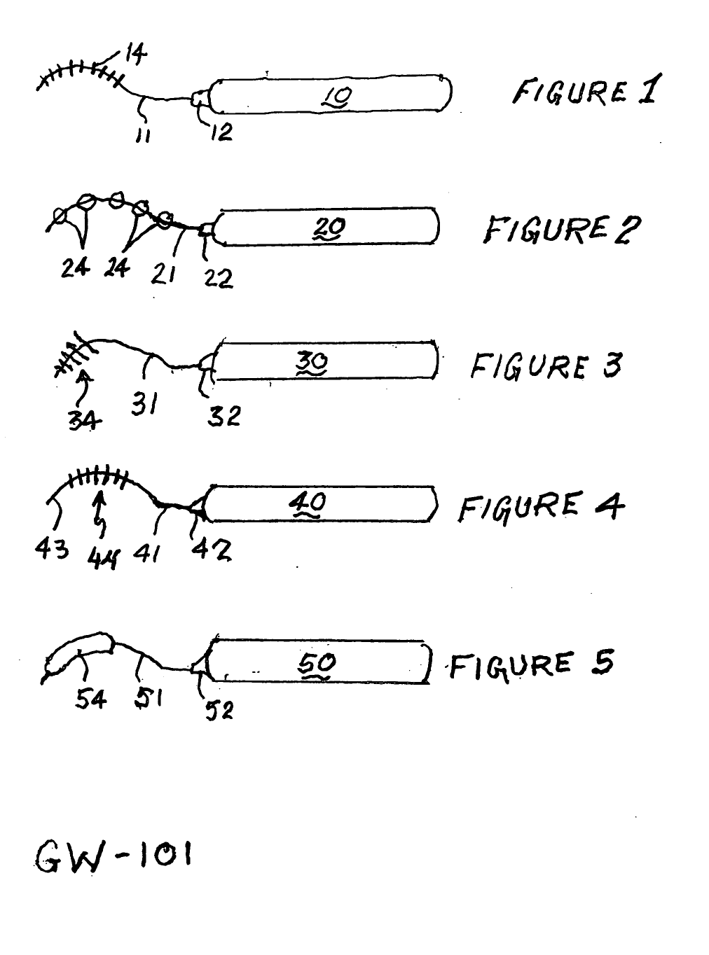

Now referring to FIG. 1, a first embodiment of this invention is shown. The first embodiment comprises a handheld base member 10. A curved, substantially rigid, (non-flexible) wire probe 11 projects from the distal end 12 of the base member 10. A brush 14 is disposed along the curved surface of the curved probe 11. The wire probe 11 can comprise stainless steel, or titanium, molybdenum, alloys thereof, and rigid, FDA grade plastic. The curved surface of the probe may also be coated with abrasive grit.

Referring to FIG. 2, a second embodiment of the invention is illustrated. This embodiment depicts a handheld base member 20. A curved, rigid, (non-flexible) wire probe 21 projects from the distal end 22 of the base member 20. A hardened set of spaced-apart beads 24, are disposed along the curved surface of the probe 21. The beads 24 can comprise (EVA) rubber or plastic.

Referring to FIG. 3, a third embodiment of this invention is shown. This embodiment comprises a handheld base member 30. A curved, rigid, wire probe 31 projects from the distal end 32 of the base member 30. A tapered brush 34 is disposed at the end of the curved surface of the probe 31.

Referring to FIG. 4, a fourth embodiment of this invention is illustrated. This embodiment comprises a handheld base member 40. A curved, rigid, wire probe 41 projects from the distal end 42 of the base member 40. A brush 44 is disposed at mid-portion of the curved surface of the probe 41. The end 43 of the wire probe 41, acts as a precursor for the brush 44, and is useful in this regard as a means of guiding the brush 44 into very tight spaces.

Referring to FIG. 5, a fifth embodiment of this invention is depicted. The fifth embodiment shows a curved, rigid wire probe 51 attached to a handheld base 50 at its distal end 52. The probe 51 has a semi-rigid foam sleeve 54 at a distal end 53 of the wire probe 51. The semi-rigid sleeve 54 is semi-abrasive, and cleans plaque and tarter-coated tooth surfaces.

Since other modifications and changes varied to fit particular operating requirements and environments will be apparent to the skilled practitioner of this art, the invention is not considered limited to the example given for purposes of disclosure, but rather is deemed to cover all changes and modifications which do not constitute departures from the true spirit and scope of the invention.

Having thus described the invention, what is desired to be protected by Letters Patent is presented in the subsequently appended claims.

What is claimed is:

1. A cleaning tool for cleaning teeth in a human host, comprising:
a handheld base member;
a curved, rigid interproximal probe having a tooth cleaning surface, said curved, rigid probe disposed from a distal end of said handheld base member; and
a tooth cleaning means disposed about said tooth cleaning surface of said curved, rigid probe, said tooth cleaning means comprising a series of rigidly beaded, spherical-shaped protuberances spaced-apart along said tooth cleaning surface of said curved rigid interproximal probe, said beaded protuberances comprising hard material that abrasively removes plaque disposed between the teeth of the human host, when said curved, rigid interproximal probe is interposed between said teeth.

2. (canceled)

3. (canceled)

4. (canceled)

5. (canceled)

6. The cleaning tool in accordance with claim 1, wherein said spaced-apart rigid beads comprise hardened plastic.

7. The cleaning tool in accordance with claim 1, wherein said spaced-apart rigid beads comprise hardened rubber.

8. The cleaning tool in accordance with claim 1, wherein said interproximal probe consists of a material selected from a group of materials consisting of: stainless steel, titanium, molybdenum, alloys thereof, and plastic.

9. (canceled)

10. A tooth cleaning kit for use in a human host to clean teeth surfaces in between said teeth along a gum baseline thereof, comprising; a plurality of curved, rigid interproximal probe elements each individually attachable to a handheld base member, each curved interproximal probe element having a tooth cleaning means attached along a cleaning surface of the interproximal probe element, said cleaning means comprising a series of spaced-apart, hard, rigid, spherical-shaped beads disposed along said cleaning surface for abrasively cleaning plaque from between the teeth of said human host, when said curved, rigid interproximal probe is inserted therebetween.

11. (canceled)

12. The tooth-cleaning kit in accordance with claim 11, wherein said spaced-apart rigid beads comprise hardened plastic.

13. The tooth-cleaning kit in accordance with claim 12, wherein said spaced-apart rigid beads comprise hardened rubber.

14. The tooth-cleaning kit in accordance with claim 10, wherein each of said interproximal probes each consist of a material selected from a group of materials consisting of: stainless steel, titanium, molybdenum, alloys thereof, and plastic.

15. (canceled)

16. A tooth-cleaning device for cleaning plaque from between teeth of a human host, comprising a handheld member, a curved, rigid wire interproximal probe carried upon a distal end of said handheld member, and a cleaning means disposed upon said curved, rigid, wire interproximal probe, said cleaning means comprising spaced-apart, rigid brush elements disposed upon said curved surface, for abrasively removing plaque from between said teeth, when said curved, rigid, interproximal wire probe is inserted therebetween.

17. The tooth-cleaning device of claim 16, wherein said curved, rigid wire interproximal probe comprises a material selected from a group of materials consisting of: stainless steel, titanium, molybdenum, and alloys thereof.

18. (canceled)

19. (canceled)

20. (canceled)

21. The tooth-cleaning tool in accordance with claim 1, wherein the series of rigidly beaded protuberances are characterized as substantially semi-circular beads.

22. The tooth cleaning kit in accordance with claim 10, wherein the series of spaced-apart, hard, rigid, beads disposed along said cleaning surface are characterized as substantially semi-circular beads.
